(19) United States
(12) Patent Application Publication
(10) Pub. No.: US 2017/0204958 A1
(43) Pub. Date: Jul. 20, 2017

(54) DRIVE PLATE AND MANUFACTURING METHOD FOR THE SAME

(71) Applicant: AISIN AW CO. LTD., Anjo-shi, Aichi-ken (JP)

(72) Inventors: Ken SHIMIZU, Anjo (JP); Kenta ITAYAMA, Anjo (JP); Shuji YAMAGUCHI, Gamagori (JP); Gen HAMADA, Toyota (JP); Hiroshi SHIBATA, Takahama (JP); Hiroki YOKOYAMA, Gamagori (JP)

(73) Assignee: AISIN AW CO. LTD., Anjo-shi, Aichi-ken (JP)

(21) Appl. No.: 15/324,127

(22) PCT Filed: Jul. 27, 2015
(86) PCT No.: PCT/JP2015/071248

§ 371 Date: Jan. 5, 2017

(30) Foreign Application Priority Data
Jul. 25, 2014 (JP) 2014-152175

(51) Int. Cl. F16H 55/17; B21K 3/00; F16H 41/24

(52) U.S. Cl. CPC F16H 55/17; F16H 41/24; B21K 3/00

(57) ABSTRACT

A drive plate having a plate portion and a ring portion is shaped integrally by pressing using dies. The ring gear portion has inner recessed portions positioned on the inner side of a plurality of outer teeth. The inner peripheral surface of each of the inner recessed portions includes an inner bottom surface having a pair of curved corner surfaces, a pair of first side surfaces inclined so as to become closer to each other as the first side surfaces extend from the opening end of the inner recessed portion toward the inner bottom surface, and a pair of second side surfaces formed in a band shape between the corner surfaces and the first side surfaces. The degree of inclination of the second side surfaces with respect to a center line is smaller than the degree of inclination of the first side surfaces with respect to the center line.

### TECHNICAL FIELD

The present disclosure relates to a drive plate that transfers power from an engine to a power transfer target, and to a manufacturing method for the same.

### BACKGROUND ART

There has hitherto been known a drive plate including a plate portion to be coupled to a crankshaft of an engine and to be coupled to a torque converter that serves as a power transfer target via set blocks, and a ring gear portion having a plurality of outer teeth to be meshed with a pinion gear of a motor that cranks the engine, the plate portion and the ring gear portion being shaped integrally by pressing (see Patent Documents 1 and 2, for example). The drive plate eliminates the need for a cutting process for a ring gear, a welding process for a plate and the ring gear, etc. compared to a configuration that includes the plate and the ring gear which are formed separately from each other and coupled to each other using bolts or the like. Thus, the manufacturing cost of the drive plate can be reduced significantly.

### RELATED-ART DOCUMENTS

### Patent Documents

[Patent Document 1] Japanese Patent Application Publication No. 10-132052 (JP 10-132052 A)

[Patent Document 2] Japanese Patent Application Publication No. 2007-170596 (JP 2007-170596 A)

### SUMMARY

In the drive plate which is shaped integrally by pressing as discussed above, materials that flow in from both sides toward the center line of each of the outer teeth in the circumferential direction of the drive plate abut against each other to form a seam (wrinkled portion) on the inner side (back side) of each of the outer teeth. At the seam which is formed on the inner side of each of the outer teeth, however, the materials which flow in from both sides are not completely joined to (mixed with) each other, and it is not easy to improve the strength around the seam. Thus, the drive plate which is shaped integrally still has room for improvement in terms of durability.

It is therefore a main object according to the present disclosure to further improve the durability of a drive plate that is shaped integrally by pressing.

The present disclosure provides a drive plate including a plate portion to be coupled to a crankshaft of an engine, and an annular ring gear portion that extends in an axial direction from an outer periphery of the plate portion and that has a plurality of outer teeth to be meshed with a drive gear of a motor that cranks the engine, the drive plate transferring power from the engine to a power transfer target. The drive plate includes: the plate portion and the ring gear portion are shaped integrally by pressing in which a plurality of dies are used; the ring gear portion is formed with a plurality of inner recessed portions such that the inner recessed portions are each positioned on an inner side of each of the plurality of outer teeth; an inner peripheral surface of each of the inner recessed portions includes an inner bottom surface, a pair of first side surfaces inclined so as to become closer to each other as the first side surfaces extend from an opening end of the inner recessed portion toward the inner bottom surface, and a pair of second side surfaces formed in a band shape between the inner bottom surface and the first side surfaces so as to extend in the axial direction; and a degree of inclination of the second side surfaces with respect to a center line that extends in a radial direction of the plate portion through a center of the inner recessed portion is smaller than a degree of inclination of the first side surfaces with respect to the center line.

In the drive plate, the plate portion and the ring gear portion are shaped integrally by pressing in which a plurality of dies are used, and the ring gear portion is formed with a plurality of inner recessed portions such that the inner recessed portion are each positioned on the inner side of each of the plurality of outer teeth. In addition, the inner peripheral surface of each of the inner recessed portions includes an inner bottom surface, a pair of first side surfaces inclined so as to become closer to each other as the first side surfaces extend from the opening end of the inner recessed portion toward the inner bottom surface, and a pair of second side surfaces formed in a band shape between the inner bottom surface and the first side surfaces so as to extend in the axial direction. The degree of inclination of the second side surfaces with respect to the center line which extends in the radial direction of the plate portion through the center of the inner recessed portion is determined to be smaller than the degree of inclination of the first side surfaces with respect to the center line.

If the second side surfaces in a band shape are formed between the inner bottom surface and the first side surfaces of each of the inner recessed portions of the ring gear portion and the degree of inclination of the second side surfaces with respect to the center line is smaller than the degree of inclination of the first side surfaces with respect to the center line as in the drive plate, the interval between both end portions of the inner bottom surface in the circumferential direction of the plate portion is increased compared to a case where the first side surfaces and the inner bottom surface are directly continuous with each other. Consequently, an inflow of materials toward an area on the inner side of the outer teeth, that is, an area between both end portions of the inner bottom surface in the circumferential direction of the plate portion, can be suppressed during pressing. Thus, it is possible to suppress formation of a seam (wrinkled portion) due to abutment of the materials which flow in from both sides between both end portions, particularly on the inner bottom surface of each of the inner recessed portions on the free end side of the ring gear portion. In addition, with the interval between both end portions of the inner bottom surface in the circumferential direction of the plate portion increased, stress concentration at the middle portion, in the circumferential direction, of the inner bottom surface, at which the seam tends to be formed, can be reduced by distributing a stress generated in the inner bottom surface of each of the inner recessed portions during cranking to both end portions of the inner bottom surface. Thus, with the drive plate, it is possible to favorably secure the strength of the ring gear portion. With the drive plate, further, thickening of the outer teeth during pressing can be promoted by an amount corresponding to the suppression of formation of a seam on the inner bottom surface of each of the inner recessed portions. As a result, with the drive plate, it is possible to improve the durability by favorably securing the strength of the ring gear portion, which is shaped integrally with the plate portion by pressing.

The present disclosure also provides a manufacturing method for a drive plate including a plate portion to be coupled to a crankshaft of an engine, and an annular ring gear portion that extends in an axial direction from an outer periphery of the plate portion and that has a plurality of outer teeth to be meshed with a drive gear of a motor that cranks the engine, the plate portion and the ring gear portion being shaped integrally by pressing in which a plurality of dies are used. The manufacturing method including:

(a) a step of forming the ring gear portion with a plurality of inner recessed portions such that the inner recessed portions are each positioned on an inner side of each of the plurality of outer teeth at least on a free end side of the ring gear portion, in which

the step (a) includes forming each of the inner recessed portions with an inner bottom surface, a pair of first side surfaces inclined so as to become closer to each other as the first side surfaces extend from an opening end of the inner recessed portion toward the inner bottom surface, and a pair of second side surfaces formed in a band shape between the inner bottom surface and the first side surfaces so as to extend in the axial direction, and making a degree of inclination of the second side surfaces with respect to a center line that extends in a radial direction of the plate portion through a center of the inner recessed portion smaller than a degree of inclination of the first side surfaces with respect to the center line.

With the method, an inflow of materials toward an area on the inner side of the outer teeth, that is, an area between both end portions of the inner bottom surface in the circumferential direction of the plate portion, can be suppressed during pressing. Thus, it is possible to suppress formation of a seam (wrinkled portion) due to abutment of the materials which flow in from both sides between both end portions, particularly on the inner bottom surface of each of the inner recessed portions on the free end side of the ring gear portion. With the method, in addition, thickening of the outer teeth during pressing can be promoted by an amount corresponding to the suppression of formation of a seam on the inner bottom surface of each of the inner recessed portions. Further, with the interval between both end portions of the inner bottom surface in the circumferential direction of the plate portion increased, it is possible to reduce stress concentration at the middle portion, in the circumferential direction, of the inner bottom surface, at which the seam tends to be formed, by distributing a stress generated in the inner bottom surface of each of the inner recessed portions during cranking to both end portions of the inner bottom surface. Thus, with the method, the durability can be improved by favorably securing the strength of the ring gear portion, which is shaped integrally with the plate portion by pressing.

### BRIEF DESCRIPTION OF THE DRAWINGS

FIG. 1 is a plan view illustrating a drive plate according to the present disclosure.

FIG. 2 is a sectional view taken along the line II-II in FIG. 1.

FIG. 3 is a sectional view illustrating a shaping die used to manufacture the drive plate according to the present disclosure.

FIG. 4 is an enlarged perspective view illustrating a third restraint punch that constitutes the shaping die.

FIG. 5 is an enlarged sectional view illustrating an essential portion of the third restraint punch.

FIG. 6 is an enlarged sectional view illustrating how the drive plate according to the present disclosure is manufactured.

FIG. 7 is an enlarged perspective view illustrating an essential portion of the drive plate according to the present disclosure.

FIG. 8 is an enlarged sectional view illustrating an essential portion of the drive plate according to the present disclosure.

FIG. 9 is a chart illustrating the relationship between the position, in the circumferential direction, of an inner bottom surface of an inner recessed portion in the drive plate according to the present disclosure and a drive plate according to a comparative example and a stress generated in the inner peripheral surface of the inner recessed portion on an end surface on the free end side of a ring gear portion during cranking.

FIG. 10 is a chart illustrating the relationship between the distance from the free end of the ring gear portion in the drive plate according to the present disclosure and the drive plate according to the comparative example and a stress generated around the middle portion, in the circumferential direction, of the inner bottom surface of the inner recessed portion during cranking.

FIG. 11 is an enlarged sectional view illustrating an essential portion of the drive plate according to the comparative example.

### DETAILED DESCRIPTION

Now, an embodiment according to the present disclosure will be described with reference to the drawings.

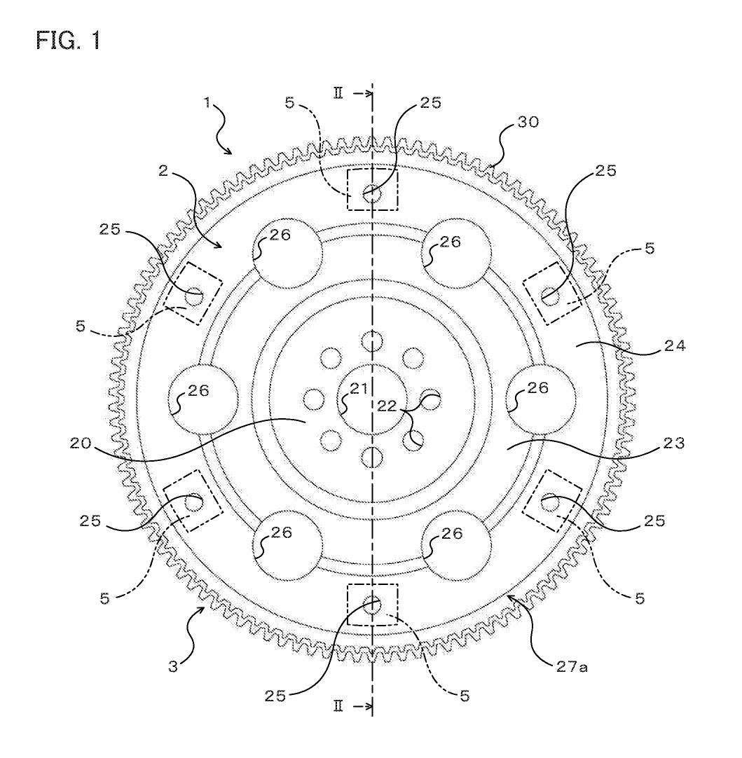

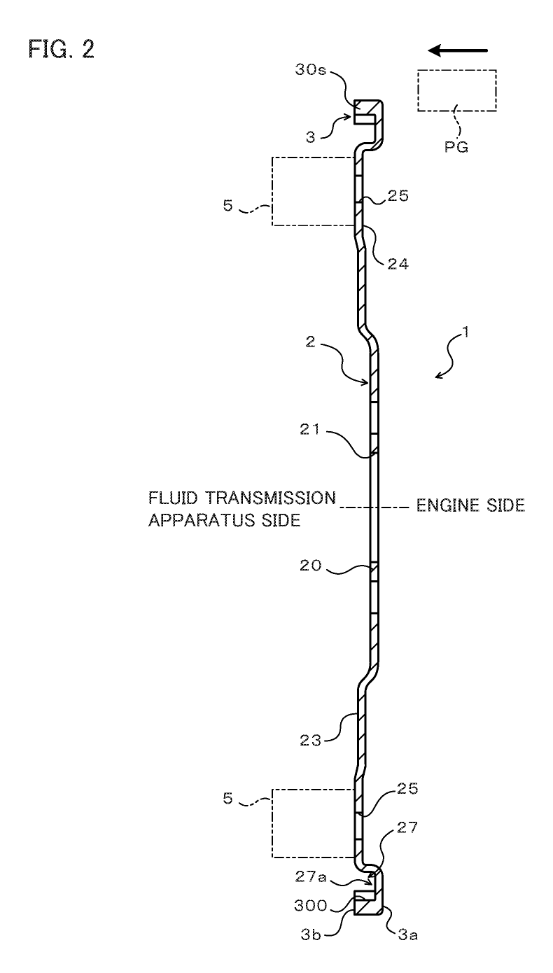

FIG. 1 is a plan view illustrating a drive plate 1 according to an embodiment according to the present disclosure. FIG. 2 is a sectional view taken along the line II-II in FIG. 1. The drive plate 1 illustrated in the drawings is used to transfer power output from an engine (internal combustion engine) (not illustrated), which serves as a motor mounted on a vehicle, to a fluid transmission apparatus (starting device) (not illustrated), such as a torque converter or a fluid coupling, which serves as a power transfer target. As illustrated in the drawings, the drive plate 1 includes a plate portion 2 to be coupled to a crankshaft of the engine and the fluid transmission apparatus, and an annular ring gear portion 3 that can be meshed with a pinion gear (drive gear) PG (see FIG. 2) of a starter motor (not illustrated) that cranks the engine. The drive plate 1, that is, the plate portion 2 and the ring gear portion 3, are shaped integrally by pressing a flexible plate material (metal plate) such as a cold-rolled steel plate, for example.

As illustrated in the drawings, the plate portion 2 of the drive plate 1 has a flat and annular first coupling portion 20 formed at the center portion. The first coupling portion 20 is formed with a center hole 21 such that the center hole 21 is positioned in the center of the first coupling portion 20. A plurality of (in the embodiment, eight) first coupling holes 22 are disposed at equal intervals around the center hole 21. An annular flat portion 23 is formed around the first coupling portion 20 so as to project from the first coupling portion 20 toward the fluid transmission apparatus. A flat and annular second coupling portion 24 is formed around the flat portion 23 so as to project from the flat portion 23 slightly toward the fluid transmission apparatus. A plurality of (in the embodiment, six) second coupling holes 25 are formed at equal intervals in the second coupling portion 24. As illustrated in FIGS. 1 and 2, the second coupling portion 24 includes flat abutment surfaces provided around the second coupling holes 25 to abut against set blocks 5 that are welded to a front cover, for example, of the fluid transmission apparatus.

In addition, a plurality of (in the embodiment, six) weight reduction holes 26 are formed at equal intervals in the plate portion 2. In the embodiment, the weight reduction holes 26 are circular holes, and are disposed between the second coupling holes 25, which are adjacent to each other, so as to lie across the flat portion 23 and the second coupling portion 24. Further, the plate portion 2 has an annular drawn portion 27 formed so as to surround the periphery of the second coupling portion 24. In the embodiment, the drawn portion 27 is formed such that an annular recessed portion 27a opens toward the fluid transmission apparatus.

The crankshaft of the engine and the first coupling portion 20 of the plate portion 2 are fastened to each other by bolts inserted through the first coupling holes 22 such that the recessed portion 27a of the drawn portion 27 is positioned on the fluid transmission apparatus side. In addition, the set blocks 5, which are fixed to the fluid transmission apparatus, abut against the abutment surface of the second coupling portion 24 on the recessed portion 27a side, and are fastened to the plate portion 2 by bolts inserted through the second coupling holes 25. Consequently, the engine and the fluid transmission apparatus are coupled to each other via the drive plate 1, which enables power output from the engine to be transferred to the fluid transmission apparatus which serves as the power transfer target.

The ring gear portion 3 is formed to extend in a cantilever manner in the axial direction of the drive plate 1 from the outer periphery of the plate portion 2 so as to surround the recessed portion 27a of the drawn portion 27, and has a plurality of outer teeth 30 that each include a tooth surface constituted of an involute curve and a generally flat tooth tip surface, for example, and that can be meshed with the teeth of the pinion gear PG of the starter motor. In the embodiment, each of the teeth of the pinion gear PG has a tooth trace that extends in parallel with the axis. The pinion gear PG is coupled to a rotor of the starter motor (not illustrated), and moved from the engine side toward the drive plate 1 (toward the fluid transmission apparatus) when starting the engine (see FIG. 2). The teeth of the pinion gear PG are inserted between the adjacent outer teeth 30 from one end in the tooth width direction of the ring gear portion 3, that is, from a base end 3a on the engine side (entry side). The distal end (an end portion on the fluid transmission apparatus side) of the pinion gear PG is basically positioned on the base end 3a side with respect to the other end of the ring gear portion 3, that is, a free end 3b on the fluid transmission apparatus side (non-entry side). Depending on the manufacturing variability or the like, however, the distal end of the pinion gear PG may project toward the fluid transmission apparatus with respect to the free end 3b.

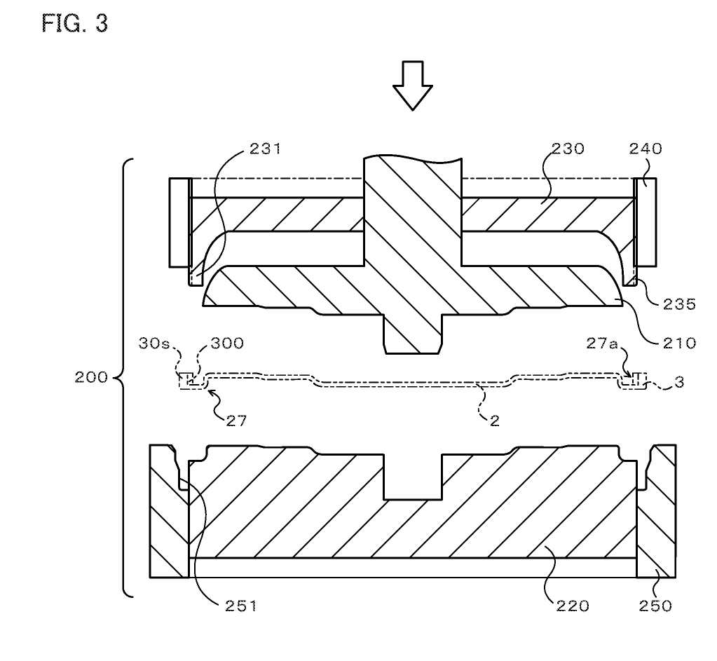

The drive plate 1 discussed above is manufactured using a shaping die 200 that includes a first restraint punch 210, a second restraint punch 220, a third restraint punch 230, a compression punch 240, and a die portion 250 illustrated in FIG. 3. The first restraint punch 210 is formed in a generally disk shape, and disposed above the second restraint punch 220 in the drawing so as to be movable toward and away from the second restraint punch 220. A surface of the first restraint punch 210 that faces the second restraint punch 220 is provided with a recessed and projected shape configured to form the first coupling portion 20, the flat portion 23, and the second coupling portion 24 of the plate portion 2. The second restraint punch 220 is formed in a generally circular column shape, and disposed in the die portion 250 so as to be movable together with the first restraint punch 210 in the up-down direction in FIG. 3 with respect to the die portion 250. A surface of the second restraint punch 220 that faces the first restraint punch 210 is also provided with a recessed and projected shape configured to form the first coupling portion 20, the flat portion 23, the second coupling portion 24, and the drawn portion 27 of the plate portion 2.

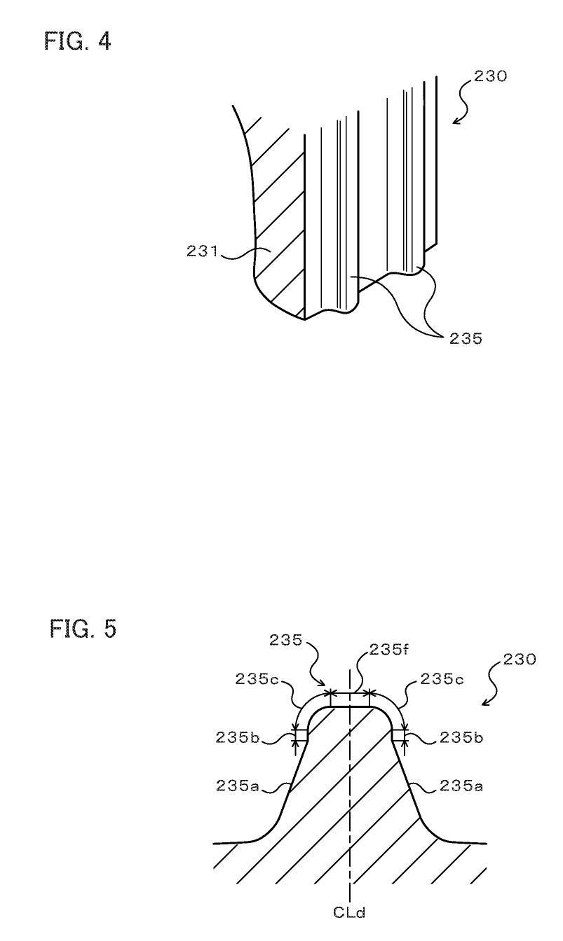

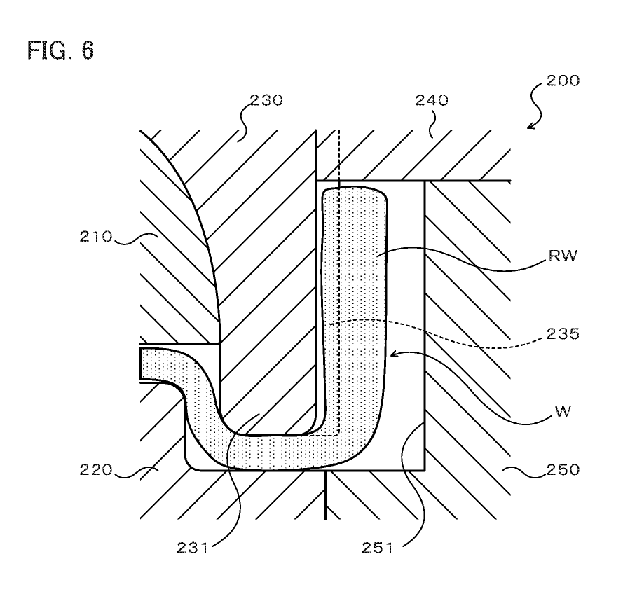

The third restraint punch 230 has an annular shaping portion 231 that surrounds the outer periphery of the first restraint punch 210 and that faces the outer peripheral portion (a recessed portion configured to form the drawn portion 27) of the second restraint punch 220. The third restraint punch 230 is disposed above the first restraint punch 210 in the drawing so as to be movable in the up-down direction in FIG. 3 with respect to the first restraint punch 210 and be movable together with the first and second restraint punches in the up-down direction in FIG. 3 with respect to the die portion 250. As illustrated in FIG. 4, in addition, a (plural) number of projecting portions 235 are formed on the outer peripheral surface of the annular shaping portion 231 of the third restraint punch 230, the number corresponding to the number of the teeth of the ring gear portion 3 of the drive plate 1, so as to project in the radial direction of the third restraint punch 230 and extend in the up-down direction in the drawing, that is, along the direction of movement of the third restraint punch 230 (the axial direction of the ring gear portion 3). In the embodiment, the length of the projecting portions 235 in the direction of movement of the third restraint punch 230 (the up-down direction in FIG. 3) is determined to be larger than the depth of the recessed portion 27a of the drive plate 1. As illustrated in FIG. 5, in addition, each of the projecting portions 235 of the third restraint punch 230 includes a pair of first shaping surfaces 235a, a pair of second shaping surfaces 235b, and a pair of corner shaping surfaces 235c.

The pair of first shaping surfaces 235a are inclined so as to become closer to each other as the first shaping surfaces 235a extend from the outer peripheral surface of the annular shaping portion 231, that is, the base end portion of the projecting portion 235, toward the distal end portion, and extend in the axial direction of the third restraint punch 230. The second shaping surfaces 235b are formed in a thin band shape between the first shaping surfaces 235a and the corner shaping surfaces 235c so as to extend in the axial direction of the third restraint punch 230. In the embodiment, the second shaping surfaces 235b are formed in parallel with a center line CLd that extends in the radial direction of the third restraint punch 230 through the center, in the circumferential direction, of the annular shaping portion 231 (third restraint punch 230) of the projecting portion 235, and have a width (a length in the radial direction of the third restraint punch 230) of about several tenths of a millimeter, for example. Thus, as illustrated in FIG. 5, the degree of inclination (the absolute value of the inclination angle) of the second shaping surfaces 235b with respect to the center line CLd is smaller than the degree of inclination (the absolute value of the inclination angle) of the first shaping surfaces 235a with respect to the center line CLd. The pair of corner shaping surfaces 235c extend in the axial direction of the third restraint punch 230 along shoulder portions at the distal end portion of the projecting portion 235. In the embodiment, the corner shaping surfaces 235c have a circular column surface that projects outward from the axial center side of the third restraint punch 230. Further, each of the projecting portions 235 includes a flat shaping surface 235f that extends in the axial direction of the third restraint punch 230 and that is formed between the pair of corner shaping surfaces 235c so as to extend orthogonally to the center line CLd.

The compression punch 240 is formed in a generally annular shape, and disposed so as to surround the third restraint punch 230 and be movable in the up-down direction in FIG. 3 with respect to the third restraint punch 230 etc. In addition, a plurality of recessed portions (not illustrated) that engage with the projecting portions 235 which are formed on the annular shaping portion 231 of the third restraint punch 230 are formed in the inner peripheral surface of the compression punch 240. The die portion 250 is formed in a generally annular shape, and disposed so as to surround the second restraint punch 220. An inner peripheral surface 251 of the die portion 250 has a drawing shaping portion positioned on the first restraint punch 210 side, that is, on the upper side in FIG. 3, and a reduced-diameter tooth shaping portion positioned below the drawing shaping portion in FIG. 3. A tooth shape configured to form the plurality of outer teeth 30 of the ring gear portion 3 is provided on the inner peripheral surface 251 of the die portion 250.

In manufacturing the drive plate 1 of an integral type using the shaping die 200, first, a disk-shaped workpiece W constituted of a cold-rolled steel plate or the like, for example, is placed on the second restraint punch 220, and the first restraint punch 210 and the third restraint punch 230 are moved toward the second restraint punch 220 (downward in FIG. 3) to apply a pressing load to the workpiece W. Consequently, the workpiece W is formed with a stepped shape corresponding to the first coupling portion 20, the flat portion 23, the second coupling portion 24, and the drawn portion 27 of the plate portion 2.

Subsequently, a state in which the workpiece W is interposed and restrained by the first restraint punch 210, the second restraint punch 220, and the third restraint punch 230 is maintained, and the first to third restraint punches 210 to 230 are moved with respect to the die portion 250 to apply a pressing load to the workpiece W (reduced-diameter shaping process). Consequently, as illustrated in FIG. 6, an annular wall portion RW that extends in a cantilever manner in the axial direction is formed at the outer periphery of the workpiece W, and the annular wall portion RW is reduced in diameter and formed with a tooth shape by the third restraint punch 230 and a reduced-diameter shaping portion of the die portion 250.

Next, with the workpiece W interposed and restrained by the first to third restraint punches 210 to 230, only the compression punch 240 is moved (advanced) with respect to the die portion 250 to apply a pressing load to the workpiece W (thickened tooth shaping process). Consequently, with the third restraint punch 230 disposed on the inner side of the annular wall portion RW of the workpiece W and with the die portion 250 disposed on the outer side of the annular wall portion RW, the annular wall portion RW is compressed by the compression punch 240 so that the annular wall portion RW is formed with a plurality of thickened teeth (outer teeth 30). In this event, an inflow of materials (movement of materials) from both sides toward the radially inner side into an area between the projecting portions 235 and the reduced-diameter tooth shaping portion of the die portion 250 is suppressed by the plurality of projecting portions 235 of the third restraint punch 230, and thus the materials are charged from the radially outer side.

After the completion of application of a pressing load, the first to third restraint punches 210 to 230 and the compression punch 240 are moved away (retracted) from the die portion 250. Further, the first restraint punch 210, the third restraint punch 230, and the compression punch 240 are moved away (retracted) from the second restraint punch 220, and the shaped article (drive plate 1) is taken out of the shaping die 200. The restraint on the workpiece by the first to third restraint punches 210 to 230 may be canceled when the reduced-diameter shaping process is completed, and the thickened tooth shaping process may be executed (in another process) using a different compression punch, die, or the like.

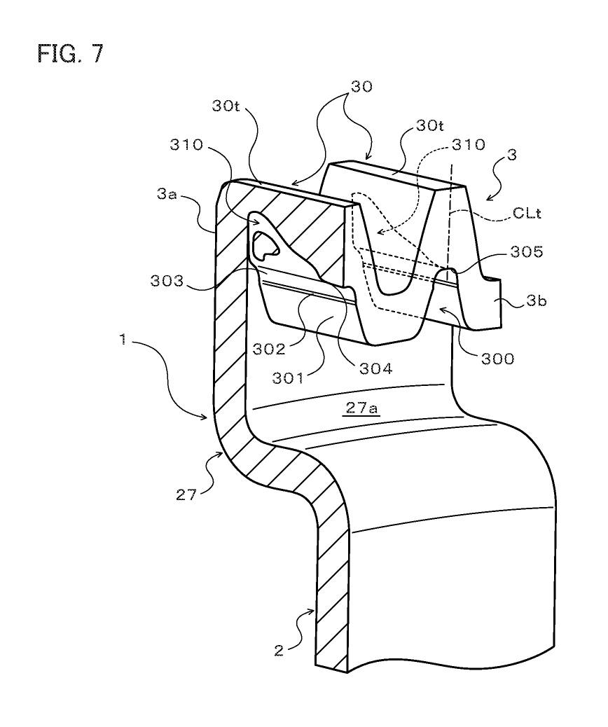

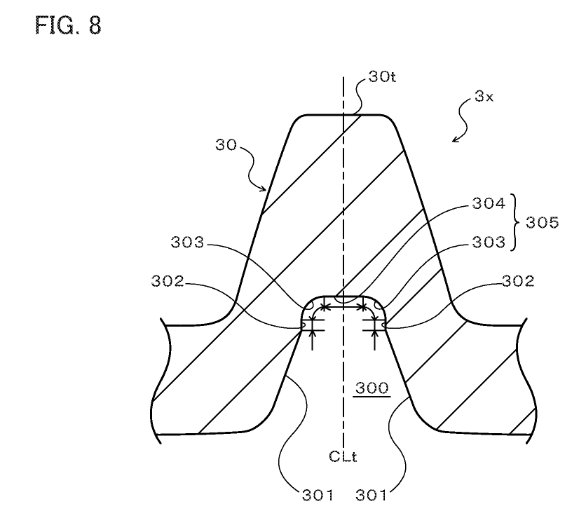

FIG. 7 is an enlarged perspective view illustrating an essential portion of the drive plate 1 manufactured as discussed above. FIG. 8 is an enlarged sectional view illustrating an essential portion of the sectional shape of the ring gear portion 3 in the vicinity of an end surface on the free end 3b side. As illustrated in the drawings, the ring gear portion 3 of the drive plate 1 is formed with a plurality of inner recessed portions 300 such that the inner recessed portions 300 are each positioned on the inner side (on the inner side in the radial direction of the drive plate 1) of each of the plurality of outer teeth 30. In the embodiment, the inner recessed portions 300 are formed to extend from the free end 3b of the ring gear portion 3 to the bottom surface of the recessed portion 27a (a surface of the plate portion 2 on the free end 3b side), that is, generally over the entirety, in the axial direction, of the inner peripheral surface of the ring gear portion 3.

As illustrated in FIGS. 7 and 8, the inner peripheral surface of each of the inner recessed portions 300 is constituted of a pair of first side surfaces 301, a pair of second side surfaces 302, and an inner bottom surface 305 that includes a pair of corner surfaces 303. The pair of first side surfaces 301 are shaped by the first shaping surfaces 235a which are included in the projecting portion 235 of the third restraint punch 230 discussed above, are inclined so as to become closer to each other as the first side surfaces 301 extend from the opening end of the inner recessed portion 300 toward the inner bottom surface 305, and extend in the axial direction of the ring gear portion 3 (drive plate 1). The first side surfaces 301 may be flat surfaces such as those illustrated in the drawings, or may be gentle curved surfaces (e.g. involute curved surfaces) that extend from the opening end of the inner recessed portion 300 toward the second side surfaces 302 and that are smoothly continuous with the second side surfaces 302. In addition, the second side surfaces 302 are shaped by the second shaping surfaces 235b which are included in the projecting portion 235 of the third restraint punch 230 into a thin band shape between the first side surfaces 301 and the corner surfaces 303 so as to extend in the axial direction of the ring gear portion 3 (drive plate 1). Further, the pair of corner surfaces 303 are shaped in a recessed circular columnar surface shape by the corner shaping surfaces 235c which are included in the projecting portion 235 of the third restraint punch 230, and extend in the axial direction of the ring gear portion 3 (drive plate 1).

In the embodiment, as illustrated in FIG. 8, the pair of second side surfaces 302 are formed so as not to be spaced away from each other from the opening end of the inner recessed portion 300 toward the inner bottom surface 305, and are generally parallel to a center line CLt that extends in the radial direction of the plate portion 2 (drive plate 1) through the center (center in the circumferential direction of the drive plate 1) of the inner recessed portion 300 (outer teeth 30). Thus, the degree of inclination (the absolute value of the inclination angle) of the second side surfaces 302 with respect to the center line CLt is smaller than the degree of inclination (the absolute value of the inclination angle) of the first side surfaces 301 with respect to the center line CLt. Consequently, the interval (the interval between both end portions of the inner bottom surface 305 in the circumferential direction of the plate portion 2) between the pair of corner surfaces 303 is increased compared to a case where the first side surfaces 301 and the corner surfaces 303 (inner bottom surface 305) are directly continuous with each other.

That is, the projecting portion 235 of the third restraint punch 230, which is configured to form the inner recessed portion 300, is formed with the second shaping surface 235b in a thin band shape between the first shaping surfaces 235a, which are configured to shape the first side surfaces 301, and the corner shaping surfaces 235c, which are configured to shape the corner surfaces 303, and the degree of inclination of the second shaping surfaces 235b with respect to the center line CLd of the projecting portion 235 is smaller than the degree of inclination of the first shaping surfaces 235a with respect to the center line CLd. Consequently, the interval (the interval in the circumferential direction of the third restraint punch 230) between the pair of corner shaping surfaces 235c is increased compared to a case where the first shaping surfaces 235a and the corner shaping surfaces 235c are directly continuous with each other, which can suppress an inflow of materials toward an area on the inner side of the outer teeth 30, that is, an area between the pair of corner surfaces 303 (the pair of corner shaping surfaces 235c) of the inner recessed portion 300, during pressing (the reduced-diameter shaping process and the thickened tooth shaping process).

As a result, in the drive plate 1, as illustrated in FIG. 7, although a seam (wrinkled portion) 310 is formed in a region (around the middle portion in the circumferential direction) of the inner bottom surface 305 of each of the inner recessed portions 300 on the base end 3a side because of abutment of materials that flow in from both sides between the pair of corner surfaces 303 (the pair of corner shaping surfaces 235c) when the outer teeth of the annular wall portion RW is thickened from the base end side, the seam 310 can be prevented from reaching the free end 3b. Thus, as illustrated in FIGS. 7 and 8, the inner bottom surface 305 of the inner recessed portion 300 includes the flat surface 304, which is shaped by the flat shaping surface 235f of the third restraint punch 230, on the free end 3b side. In the embodiment, the flat surface 304 is formed between an end surface on the free end 3b side of the ring gear portion 3 and a position a distance of about 8 to 30% of the axial length of the ring gear portion 3, for example, away from the end surface toward the base end 3a.

In addition, in the drive plate 1, as discussed above, an inflow of materials toward an area between the pair of corner surfaces 303 is suppressed by the projecting portion 235 of the third restraint punch 230, and the plurality of inner recessed portions 300 are formed in the range from the free end 3b to the bottom surface (a surface of the plate portion 2 on the free end 3b side) of the recessed portion 27a. Consequently, thickening of the outer teeth during pressing can be promoted while suppressing formation of the seam 310 on the inner bottom surface 305 of the inner recessed portion 300. Thus, the manufacturing cost of the drive plate 1 can be further reduced by omitting tooth shape finishing.

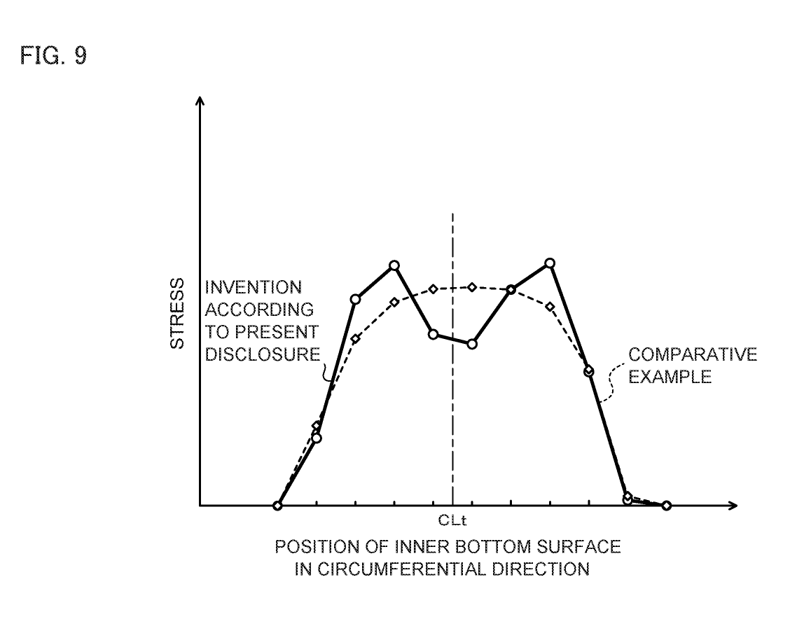

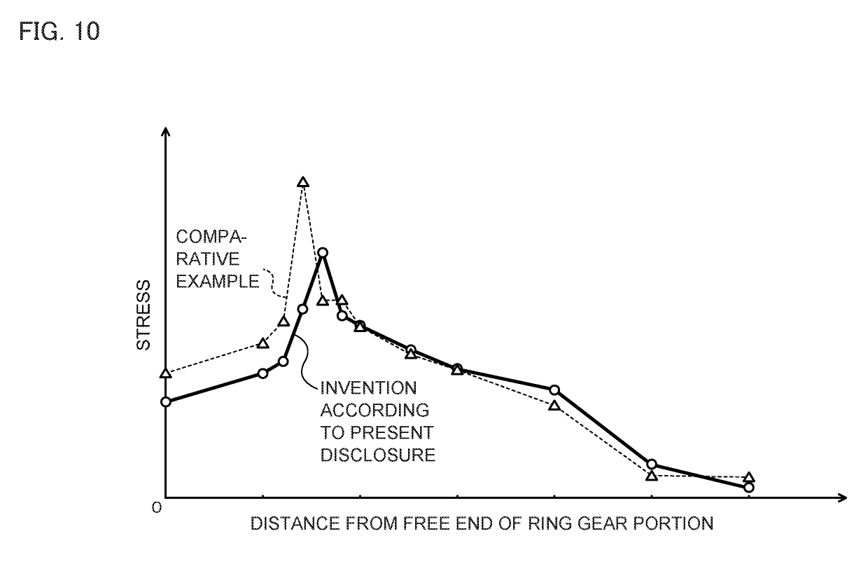

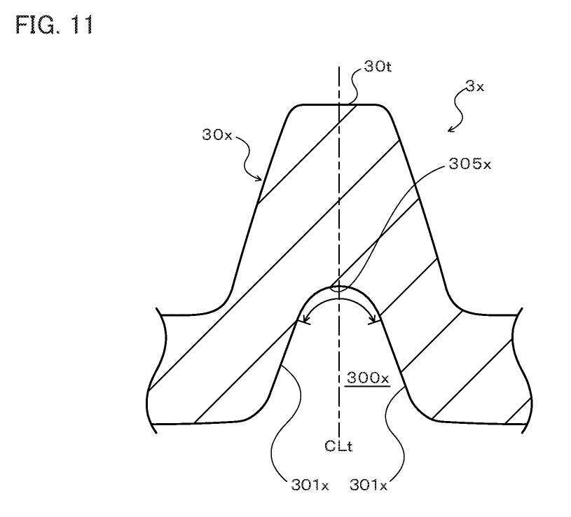

FIG. 9 is a chart illustrating the relationship between the position, in the circumferential direction, of the inner bottom surface of the inner recessed portion in the drive plate 1 and a drive plate according to a comparative example and a stress generated in the inner peripheral surface of the inner recessed portion on an end surface on the free end side of the ring gear portion during cranking. FIG. 10 is a chart illustrating the relationship between the distance from the free end of the ring gear portion in the drive plate 1 discussed above and the drive plate according to the comparative example and a stress generated around the middle portion, in the circumferential direction, of the inner bottom surface of the inner recessed portion.

FIG. 11 illustrates the sectional shape of a ring gear portion 3x of the drive plate according to the comparative example in the vicinity of an end surface on the free end side. As with the drive plate 1 discussed above, the drive plate according to the comparative example includes a plate portion (not illustrated) and the ring gear portion 3x which are shaped integrally by pressing. As illustrated in FIG. 11, the ring gear portion 3x is formed with a plurality of inner recessed portions 300x such that the inner recessed portions 300x are each positioned on the inner side (on the inner side in the radial direction of the drive plate 1) of each of a plurality of outer teeth 30x. The inner recessed portions 300x are also formed in the range from the free end of the ring gear portion 3x to a surface on the free end side of the plate portion (not illustrated).

The inner peripheral surface of each of the inner recessed portions 300x is constituted of a pair of first side surfaces 301x and an inner bottom surface 305x in a recessed curved surface shape that is continuous with the pair of first side surfaces 301x, and does not include the second side surfaces 302 of the drive plate 1. Also in the drive plate according to the comparative example, a seam (wrinkled portion) is formed in a region (around the middle portion in the circumferential direction) of the inner bottom surface 305x of each of the inner recessed portions 300x on the base end side. As illustrated in FIG. 11, however, the inner bottom surface 305x on the free end side of the ring gear portion 3x has a recessed curved surface shape, and does not include the flat surface 304 of the drive plate 1. A third restraint punch configured to manufacture the drive plate according to the comparative example has a (plural) number of projecting portions, the number corresponding to the number of the teeth of the ring gear portion 3x, as with the third restraint punch 230 discussed above. Each of the projecting portions includes a pair of first shaping surfaces configured to shape the first side surfaces 301x and a curved shaping surface configured to shape the inner bottom surface 305x, and does not include the pair of second shaping surfaces 235b or the flat shaping surface 235f, unlike the third restraint punch 230.

As illustrated in FIG. 9, in the drive plate according to the comparative example, a stress generated in the inner peripheral surface of the inner recessed portion on an end surface on the free end side of the ring gear portion when the engine is cranked is increased from end portions of the first side surfaces 301x on the opening end side toward the center line CLt, that is, toward the middle portion in the circumferential direction of the drive plate, to be maximized around the middle portion. In the drive plate 1, in contrast, the stress is increased from end portions of the first side surfaces 301x on the opening end side toward the center line CLt, that is, toward the middle portion in the circumferential direction of the drive plate, to be maximized on the corner surfaces 303. Then, the stress is reduced from the corner surfaces 303 toward the center line CLt. The stress around the middle portion in the circumferential direction of the flat surface 304 is smaller than the stress around the center line CLt in the drive plate according to the comparative example.

In the drive plate 1, in this way, the interval between the pair of corner surfaces 303 is increased, and the flat surface 304 is provided on the free end 3b side of the inner bottom surface 305. Thus, a stress generated in the inner bottom surface 305 of the inner recessed portion 300 during cranking can be distributed to the pair of corner surfaces 303 to favorably reduce stress concentration at the middle portion, in the circumferential direction, of the inner bottom surface 305, at which the seam 310 tends to be formed. Even if the stress on the corner surfaces 303 of the inner recessed portion 300 is enhanced as illustrated in FIG. 9, the seam (wrinkled portion) such as that discussed above is not formed on the corner surfaces 303, and the value of the stress itself is sufficiently smaller than the allowable stress of the constituent material of the drive plate, which causes no hindrance in practice.

Further, as illustrated in FIG. 10, a stress generated around the middle portion, in the circumferential direction, of the inner bottom surface 305 of the inner recessed portion 300 of the drive plate 1 is smaller than that for the drive plate according to the comparative example for the entire inner recessed portion 300 in the axial direction of the ring gear portion 3. In both the drive plate 1 and the drive plate according to the comparative example, in addition, a seam (wrinkled portion) is not formed at the middle portion of the inner bottom surface 305, 305x, or the like. Thus, a stress generated in the inner bottom surface 305, 305x in the vicinity of the free end of the ring gear portion 3, 3x is reduced. It should be noted, however, that in the drive plate according to the comparative example, the seam (wrinkled portion) discussed above extends closer to the free end of the ring gear portion than that in the drive plate 1, and a stress on the free end side of the ring gear portion is accordingly larger than that in the drive plate 1. As a result of the stress analyses illustrated in FIGS. 9 and 10, it is understood that the strength of the ring gear portion 3 can be secured extremely favorably with the drive plate 1 compared to the drive plate according to the comparative example.

In the drive plate 1, as discussed above, the second side surfaces 302 in a band shape are formed between the inner bottom surface 305 (corner surfaces 303) and the first side surfaces 301 of the inner recessed portion 300 of the ring gear portion 3, and the degree of inclination of the second side surfaces 302 with respect to the center line CLt is determined to be smaller than the degree of inclination of the first side surfaces 301 with respect to the center line CLt. Consequently, the durability can be improved by favorably securing the strength of the ring gear portion 3, which is shaped integrally with the plate portion 2 by pressing, while suppressing a cost increase by omitting tooth shape finishing.

In addition, by shaping the second side surfaces 302 in a thin band shape using the third restraint punch 230 which constitutes the shaping die 200, an inflow of materials toward an area between the pair of corner surfaces 303 (the pair of corner shaping surfaces 235c) of the inner bottom surface 305 can be regulated by the third restraint punch 230, suppressing formation of the seam 310 due to abutment of the materials which flow in.

Further, if the pair of second side surfaces 302 are formed so as not to be spaced away from each other from the opening end of the inner recessed portion 300 toward the inner bottom surface 305, the second side surfaces 302 can be smoothly continuous with both the first side surfaces 301 and the corner surfaces 303. It should be noted, however, that the pair of second side surfaces 302 may be formed to be (slightly) spaced away from each other from the opening end of the inner recessed portion 300 toward the inner bottom surface 305.

In addition, each of the projecting portions 235 of the third restraint punch 230 includes, as surfaces for shaping the inner bottom surface 305, the pair of corner shaping surfaces 235c and the flat shaping surface 235f which is formed between the pair of corner shaping surfaces 235c. The inner bottom surface 305 of each of the inner recessed portions 300 of the drive plate 1 includes the pair of corner surfaces 303 which are shaped by the corner shaping surfaces 235c, and the flat surface 304 which is shaped by the flat shaping surface 235f and which is provided between the pair of corner surfaces 303 at least on the free end 3b side of the ring gear portion 3. In this way, it is possible to further increase the interval between the pair of corner shaping surfaces 235c by providing the projecting portion 235 with the flat shaping surface 235f, and it is possible to favorably suppress formation of the seam (wrinkled portion) 310 on the inner bottom surface 305 on the free end 3b side of the ring gear portion 3 while further favorably regulating an inflow of materials into an area between the pair of corner shaping surfaces 235c from both sides during pressing (thickened tooth shaping process). Further, with the flat surface 304 formed on the inner bottom surface 305 on the free end 3b side of the ring gear portion 3, stress concentration at the middle portion, in the circumferential direction, of the inner bottom surface 350 can be reduced further favorably by distributing a stress generated in the inner bottom surface 305 of the inner recessed portion 300 during cranking to the pair of corner surfaces 303. As a result, it is possible to improve the durability by further favorably securing the strength of the ring gear portion 3, which is shaped integrally with the plate portion 2 by pressing.

It should be noted, however, that the flat shaping surface 235f may be omitted from each of the projecting portions 235 of the third restraint punch 230, and that the inner bottom surface 305 of the inner recessed portion 300 may not have the flat surface 304 on the free end 3b side of the ring gear portion 3. That is, the pair of corner surfaces 303 of the inner bottom surface 305 may be continuous with each other, without a flat surface interposed therebetween, on the free end 3b side of the ring gear portion 3.

As has been described above, the present disclosure provides a drive plate including a plate portion (2) to be coupled to a crankshaft of an engine, and an annular ring gear portion (3) that extends in an axial direction from an outer periphery of the plate portion (2) and that has a plurality of outer teeth (30) to be meshed with a drive gear (PG) of a motor that cranks the engine, the drive plate (1) transferring power from the engine to a power transfer target. The drive plate (1) includes: the plate portion (2) and the ring gear portion (3) are shaped integrally by pressing in which a plurality of dies (210, 220, 230, 240, 250) are used; the ring gear portion (3) is formed with a plurality of inner recessed portions (300) such that the inner recessed portions (300) are each positioned on an inner side of each of the plurality of outer teeth (30); an inner peripheral surface of each of the inner recessed portions (300) includes an inner bottom surface (305), a pair of first side surfaces (301) inclined so as to become closer to each other as the first side surfaces (301) extend from an opening end of the inner recessed portion (300) toward the inner bottom surface (305), and a pair of second side surfaces (302) formed in a band shape between the inner bottom surface (305) and the first side surfaces (301) so as to extend in the axial direction; and a degree of inclination of the second side surfaces (302) with respect to a center line (CLt) that extends in a radial direction of the plate portion (2) through a center of the inner recessed portion (300) is smaller than a degree of inclination of the first side surfaces (301) with respect to the center line (CLt).

In the drive plate, the plate portion and the ring gear portion are shaped integrally by pressing in which a plurality of dies are used, and the ring gear portion is formed with a plurality of inner recessed portions such that the inner recessed portions are each positioned on the inner side of each of the plurality of outer teeth. In addition, the inner peripheral surface of each of the inner recessed portions includes an inner bottom surface, a pair of first side surfaces inclined so as to become closer to each other as the first side surfaces extend from the opening end of the inner recessed portion toward the inner bottom surface, and a pair of second side surfaces formed in a band shape between the inner bottom surface and the first side surfaces so as to extend in the axial direction. The degree of inclination of the second side surfaces with respect to the center line which extends in the radial direction of the plate portion through the center of the inner recessed portion is determined to be smaller than the degree of inclination of the first side surfaces with respect to the center line.

In this way, if the second side surfaces in a band shape are formed between the inner bottom surface and the first side surfaces of each of the inner recessed portions of the ring gear portion and the degree of inclination of the second side surfaces with respect to the center line is smaller than the degree of inclination of the first side surfaces with respect to the center line, the interval between both end portions of the inner bottom surface in the circumferential direction of the plate portion is increased compared to a case where the first side surfaces and the inner bottom surface are directly continuous with each other. Consequently, an inflow of materials toward an area on the inner side of the outer teeth, that is, an area between both end portions of the inner bottom surface in the circumferential direction of the plate portion, can be suppressed during pressing. Thus, it is possible to suppress formation of a seam (wrinkled portion) due to abutment of the materials which flow in from both sides between both end portions, particularly on the inner bottom surface of each of the inner recessed portions on the free end side of the ring gear portion. In addition, with the interval between both end portions of the inner bottom surface in the circumferential direction of the plate portion increased, stress concentration at the middle portion, in the circumferential direction, of the inner bottom surface, at which the seam tends to be formed, can be reduced by distributing a stress generated in the inner bottom surface of each of the inner recessed portions during cranking to both end portions of the inner bottom surface. Thus, with the drive plate, it is possible to favorably secure the strength of the ring gear portion. With the drive plate, further, thickening of the outer teeth during pressing can be promoted by an amount corresponding to the suppression of formation of a seam on the inner bottom surface of each of the inner recessed portions. As a result, with the drive plate, it is possible to improve the durability by favorably securing the strength of the ring gear portion, which is shaped integrally with the plate portion by pressing.

The second side surfaces (302) may be shaped surfaces shaped by any (230) of the plurality of dies. Consequently, an inflow of materials toward an area between both end portions of the inner bottom surface in the circumferential direction of the plate portion can be regulated by the die which shapes the second side surfaces, suppressing formation of a seam due to abutment of the materials which flow in.

The pair of second side surfaces (302) may be formed so as not to be spaced away from each other from the opening end of the inner recessed portion (300) toward the inner bottom surface (305). Consequently, the second side surfaces can be smoothly continuous with both the first side surfaces and the inner bottom surface.

The inner bottom surface (305) may include a pair of curved corner surfaces (303), and a flat surface (304) formed between the pair of corner surfaces (303) at least on a free end (3b) side of the ring gear portion (3). Consequently, stress concentration at the middle portion, in the circumferential direction, of the inner bottom surface can be reduced further favorably by distributing a stress generated in the inner bottom surface of each of the inner recessed portions during cranking to the pair of corner surfaces. Thus, it is possible to improve the durability by further favorably securing the strength of the ring gear portion, which is shaped integrally with the plate portion by pressing.

The present disclosure provides a manufacturing method for a drive plate (1) including a plate portion (2) to be coupled to a crankshaft of an engine, and an annular ring gear portion (3) that extends in an axial direction from an outer periphery of the plate portion (2) and that has a plurality of outer teeth (30) to be meshed with a drive gear (PG) of a motor that cranks the engine, the plate portion (2) and the ring gear portion (3) being shaped integrally by pressing in which a plurality of dies (210, 220, 230, 240, 250) are used. The manufacturing method includes:

(a) a step of forming the ring gear portion (3) with a plurality of inner recessed portions (300) such that the inner recessed portions (300) are each positioned on an inner side of each of the plurality of outer teeth (30) at least on a free end (3b) side of the ring gear portion (3), in which

the step (a) includes forming each of the inner recessed portions (300) with an inner bottom surface (305), a pair of first side surfaces (301) inclined so as to become closer to each other as the first side surfaces (301) extend from an opening end of the inner recessed portion (300) toward the inner bottom surface (305), and a pair of second side surfaces (302) formed in a band shape between the inner bottom surface (305) and the first side surfaces (301) so as to extend in the axial direction, and making a degree of inclination of the second side surfaces (302) with respect to a center line (CLt) that extends in a radial direction of the plate portion (2) through a center of the inner recessed portion (300) smaller than a degree of inclination of the first side surfaces (301) with respect to the center line (CLt).

With the method, an inflow of materials toward an area on the inner side of the outer teeth, that is, an area between both end portions of the inner bottom surface in the circumferential direction of the plate portion, can be suppressed during pressing. Thus, it is possible to suppress formation of a seam (wrinkled portion) due to abutment of the materials which flow in from both sides between both end portions, particularly on the inner bottom surface of each of the inner recessed portions on the free end side of the ring gear portion. With the method, in addition, thickening of the outer teeth during pressing can be promoted by an amount corresponding to the suppression of formation of a seam on the inner bottom surface of each of the inner recessed portions. Further, with the interval between both end portions of the inner bottom surface in the circumferential direction of the plate portion increased, it is possible to reduce stress concentration at the middle portion, in the circumferential direction, of the inner bottom surface, at which the seam tends to be formed, by distributing a stress generated in the inner bottom surface of each of the inner recessed portions during cranking to both end portions of the inner bottom surface. Thus, with the method, the durability can be improved by favorably securing the strength of the ring gear portion, which is shaped integrally with the plate portion by pressing.

The step (a) may include compressing an annular wall portion (RW), which is formed in a workpiece (W), using a compression punch (240) with a restraint punch (230) disposed on an inner side of the annular wall portion (RW) and with a die portion (250) disposed on an outer side of the annular wall portion (RW). The restraint punch (230) may have a plurality of projecting portions (235) that project in a radial direction toward an inner peripheral surface of the annular wall portion (RW). Each of the projecting portions (235) of the restraint punch (230) may include a shaping surface (235c, 235f) for the inner bottom surface (305), which is formed at a distal end portion, a pair of first shaping surfaces (235a) inclined so as to become closer to each other as the first shaping surfaces (235a) extend from a base end portion of the projecting portion (235) toward the distal end portion, and a pair of second shaping surfaces (235b) formed in a band shape between the shaping surface (235c) for the inner bottom surface (305) and the first shaping surfaces (235a). A degree of inclination of the second shaping surfaces (235b) with respect to a center line (CLd) that extends in a radial direction of the restraint punch (230) through a center of the projecting portion (235) may be smaller than a degree of inclination of the first shaping surfaces (235a) with respect to the center line (CLd). Consequently, thickening of the outer teeth can be promoted while suppressing formation of the seam (wrinkled portion), particularly on the inner bottom surface of each of the inner recessed portions on the free end side of the ring gear portion, with the plurality of projecting portions of the restraint punch regulating movement of materials when the compression punch is moved with respect to the restraint punch and the die portion to thicken the outer teeth of the annular wall portion (ring gear portion).

The shaping surface for the inner bottom surface (305) may include a pair of curved corner shaping surfaces (235c) formed at the distal end portion, and a flat shaping surface (235f) formed between the pair of corner shaping surfaces (235c). Consequently, the interval between the pair of corner shaping surfaces can be further increased. Thus, an inflow of materials into an area between the pair of corner shaping surfaces from both sides during pressing can be regulated further favorably, favorably suppressing formation of the seam (wrinkled portion), particularly on the inner bottom surface of each of the inner recessed portions on the free end side of the ring gear portion.

The present disclosure is not limited to the embodiment described above in any way, and it is a matter of course that the disclosure may be modified in various ways without departing from the range of the extension of the present disclosure. In addition, the mode for carrying out the present disclosure described above is merely a specific form of the disclosure described in the “SUMMARY” section, and does not limit the elements of the invention described in the “SUMMARY” section.

### INDUSTRIAL APPLICABILITY

The present disclosure can be utilized in the field of manufacture of a drive plate that transfers power from an engine to a power transfer target.

1-7. (canceled)

8. A drive plate comprising:
a plate portion to be coupled to a crankshaft of an engine, and
an annular ring gear portion that extends in an axial direction from an outer periphery of the plate portion and that has a plurality of outer teeth to be meshed with a drive gear of a motor that cranks the engine, the drive plate transferring power from the engine to a power transfer target, wherein
the plate portion and the ring gear portion are shaped integrally by pressing in which a plurality of dies are used,
the ring gear portion is formed with a plurality of inner recessed portions such that the inner recessed portions are each positioned on an inner side of each of the plurality of outer teeth,
an inner peripheral surface of each of the inner recessed portions includes an inner bottom surface, a pair of first side surfaces inclined so as to become closer to each other as the first side surfaces extend from an opening end of the inner recessed portion toward the inner bottom surface, and a pair of second side surfaces formed in a band shape between the inner bottom surface and the first side surfaces so as to extend in the axial direction, and
a degree of inclination of the second side surfaces with respect to a center line that extends in a radial direction of the plate portion through a center of the inner recessed portion is smaller than a degree of inclination of the first side surfaces with respect to the center line.

9. The drive plate according to claim 8, wherein
the second side surfaces are shaped surfaces shaped by any of the plurality of dies.

10. The drive plate according to claim 8, wherein
the pair of second side surfaces are formed so as not to be spaced away from each other from the opening end of the inner recessed portion toward the inner bottom surface.

11. The drive plate according to claim 8, wherein
the inner bottom surface includes a pair of curved corner surfaces, and a flat surface formed between the pair of corner surfaces at least on a free end side of the ring gear portion.

12. The drive plate according to claim 9, wherein
the pair of second side surfaces are formed so as not to be spaced away from each other from the opening end of the inner recessed portion toward the inner bottom surface.

13. The drive plate according to claim 9, wherein
the inner bottom surface includes a pair of curved corner surfaces, and a flat surface formed between the pair of corner surfaces at least on a free end side of the ring gear portion.

14. The drive plate according to claim 10, wherein
the inner bottom surface includes a pair of curved corner surfaces, and a flat surface formed between the pair of corner surfaces at least on a free end side of the ring gear portion.

15. The drive plate according to claim 12, wherein
the inner bottom surface includes a pair of curved corner surfaces, and a flat surface formed between the pair of corner surfaces at least on a free end side of the ring gear portion.

16. A manufacturing method for a drive plate including a plate portion to be coupled to a crankshaft of an engine, and an annular ring gear portion that extends in an axial direction from an outer periphery of the plate portion and that has a plurality of outer teeth to be meshed with a drive gear of a motor that cranks the engine, the plate portion and the ring gear portion being shaped integrally by pressing in which a plurality of dies are used, the manufacturing method comprising:
(a) a step of forming the ring gear portion with a plurality of inner recessed portions positioned on an inner side of the plurality of outer teeth at least on a free end side of the ring gear portion, wherein
the step (a) includes forming each of the inner recessed portions with an inner bottom surface, a pair of first side surfaces inclined so as to become closer to each other as the first side surfaces extend from an opening end of the inner recessed portion toward the inner bottom surface, and a pair of second side surfaces formed in a band shape between the inner bottom surface and the first side surfaces so as to extend in the axial direction, and making a degree of inclination of the second side surfaces with respect to a center line that extends in a radial direction of the plate portion through a center of the inner recessed portion smaller than a degree of inclination of the first side surfaces with respect to the center line.

17. The manufacturing method for a drive plate according to claim 16, wherein
the step (a) includes compressing an annular wall portion, which is formed in a workpiece, using a compression punch with a restraint punch disposed on an inner side of the annular wall portion and with a die portion disposed on an outer side of the annular wall portion,
the restraint punch has a plurality of projecting portions that project in a radial direction toward an inner peripheral surface of the annular wall portion,
each of the projecting portions of the restraint punch includes a shaping surface for the inner bottom surface, which is formed at a distal end portion, a pair of first shaping surfaces inclined so as to become closer to each other as the first shaping surfaces extend from a base end portion of the projecting portion toward the distal end portion, and a pair of second shaping surfaces formed in a band shape between the shaping surface for the inner bottom surface and the first shaping surfaces, and
a degree of inclination of the second shaping surfaces with respect to a center line that extends in a radial direction of the restraint punch through a center of the projecting portion is smaller than a degree of inclination of the first shaping surfaces with respect to the center line.

18. The manufacturing method for a drive plate according to claim 17, wherein
the shaping surface for the inner bottom surface includes a pair of curved corner shaping surfaces formed at the distal end portion, and a flat shaping surface formed between the pair of corner shaping surfaces.
